(19) United States
(12) Patent Application Publication
(10) Pub. No.: US 2008/0147797 A1
(43) Pub. Date: Jun. 19, 2008

(54) Methods and system to exchange products and ideas between a plurality of parties

(76) Inventors: Deepak Ramaswamy, Ithaca, NY (US); Sunitha Balasubramanian, Tampa, FL (US); Raja Muthu, Tampa, FL (US)

Correspondence Address: MAIER & MAIER, PLLC, 1000 DUKE STREET, ALEXANDRIA, VA, 22314, US

(21) Appl. No.: 12/000,485

(22) Filed: Dec. 13, 2007

Related U.S. Application Data
(60) Provisional application No. 60/869,969, filed on Dec. 14, 2006.

(51) Int. Cl. G06F 15/16; G06F 7/06

(52) U.S. Cl. 709/204; 707/3

(57) ABSTRACT

A method of exchanging a product between a plurality of parties is provided. The method may include connecting at least one first party and at least one second party to a web portal; creating a product by the at least one second party; uploading the product to the web portal by the at least one second party; viewing the product on the web portal by the at least one first party; facilitating communication between the at least one first party and the at least one second party to enable collaboration on the product; editing the product based on the communication; and exporting the product to the at least one first party.

### CROSS-REFERENCE TO RELATED APPLICATIONS

This application claims priority to U.S. Provisional Application 60/869,969, filed Dec. 14, 2006 and entitled COLLABORATIVE INNOVATION ENVIRONMENT, the entire contents of which are hereby incorporated by reference.

### BACKGROUND OF THE INVENTION

This invention relates generally to development and innovation in a closed environment. In particular, this application relates to the environment surrounding individuals working to create new ideas, products and processes in corporate environments.

Typically, in corporate environments, innovation is sought from a group of inventors or innovators. Depending on the size of the company or corporation, this group may have anywhere from a few people to a few hundred people. This group, however, is typically limited to the resources and knowledge base of the individuals comprising their group and to the other individuals employed by the company. Thus the size of the company can have a potentially limiting effect on innovation and creativity and may prevent the realization of significant ideas or the enhancement of other ideas.

Additionally, in environments where there are fewer people or where there are limited resources, a company may suffer due to the inability to innovate or the inability to improve upon inventions and concepts. Additionally, due to corporate theft or the desire to keep trade secrets, many innovators do not have the opportunity to receive outside input on ideas or concepts.

The Internet has become a tool that allows people to congregate and discuss essentially any topic. Thousands of websites exist that allow people to have a virtual meeting place in order to promote ideas about various topics, discuss like interests, or readily seek assistance. Additionally, people regularly exchange ideas and collaborate on developing concepts.

### BRIEF DESCRIPTION OF THE INVENTION

In one aspect, a method of exchanging a product between a plurality of parties is provided. The method may include connecting at least one first party and at least one second party to a web portal; creating a product by the at least one second party; uploading the product to the web portal by the at least one second party; viewing the product on the web portal by the at least one first party; facilitating communication between the at least one first party and the at least one second party to enable collaboration on the product; editing the product based on the communication; and exporting the product to the at least one first party.

In another aspect, a computer program embodied on a computer-readable medium is provided. The computer program may include at least one code segment that is configured to instruct a computer to connect at least one first party and at least one second party to a web portal; receive a product created by the at least one second party; finalize the product; and export the product to the at least one first party.

In yet another aspect, a web system is provided. The web system may include at least one database; at least one archive; and at least one server coupled in communication with the at least one database and the at least one archive, wherein at least one first party and at least one second party may be coupled in communication to the at least one server, and the at least one server can be configured to connect the at least one first party and the at least one second party to the at least one server; receive a product created by the at least one second party; finalize the product; and export the product to the at least one first party.

### BRIEF DESCRIPTION OF THE DRAWINGS

Advantages of embodiments of the present invention will be apparent from the following detailed description of the exemplary embodiments thereof. The following detailed description should be considered in conjunction with the accompanying figures in which:

FIG. 1 is a schematic illustration of a web system;

FIG. 2 is a logical schematic illustration of a web portal that may be used with the web system shown in FIG. 1;

FIG. 3 is a flowchart of a method of connecting at least one paying client to the web portal shown in FIG. 2;

FIG. 4 is a flowchart of a method of connecting at least one web user to the web portal shown in FIG. 2; and

FIG. 5 is a logical schematic illustration of an alternate web system.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance, or illustration.” The embodiments described herein are not limiting, but rather are exemplary only. It should be understood that the described embodiment are not necessarily to be construed as preferred or advantageous over other embodiments. Moreover, the term “embodiments of the invention” does not require that all embodiments of the invention include the discussed feature, advantage or mode of operation.

Further, many of the embodiments described herein, are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

Other aspects of the present invention may include data transmission and Internet-related activities. See Gralla, Preston, How the Internet Works, Ziff-Davis Press (1996), which is hereby incorporated by reference into this patent application. Still, other aspects of the invention may utilize wireless data transmission, such as those described in U.S. Pat. Nos. 6,456,645, 5,818,328 and/or 6,208,445, all of which are hereby incorporated by reference into this patent application.

The present invention generally provides an exemplary system and methods to facilitate exchanging products and ideas between a plurality of parties. More specifically, the present invention may facilitate connecting the plurality of parties together using a virtual meeting place, or web portal, such that the plurality of parties may collaborate to achieve a common goal regarding content, concepts, products, ideas, designs, models and the like, hereinafter referred to as products. Such goals may include, but are not limited to, finalizing a product, purchasing a product and/or selling a product.

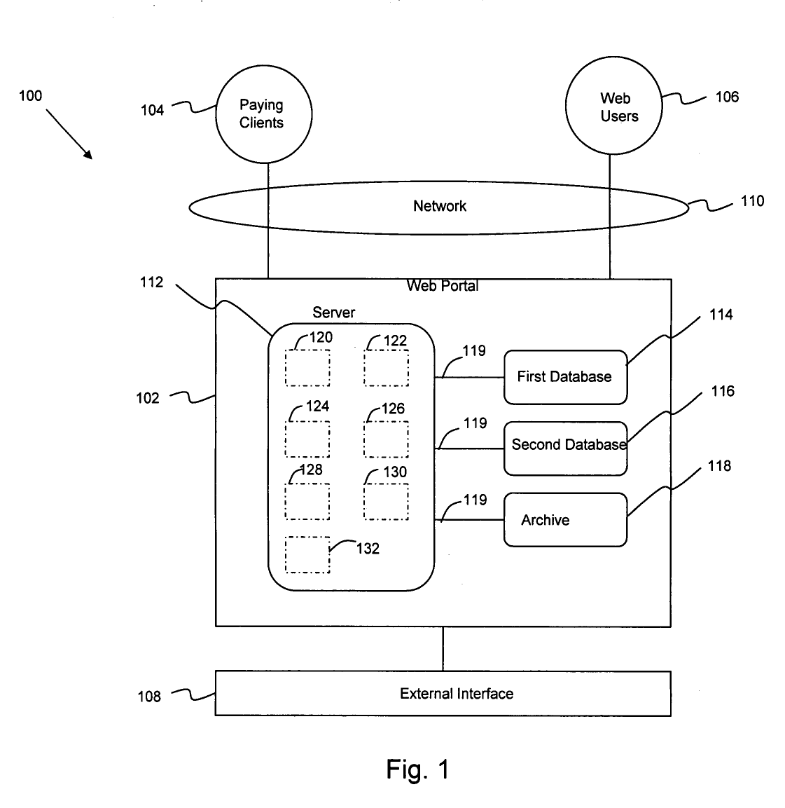

FIG. 1 is a schematic illustration of a web system 100. In the exemplary embodiment, web system 100 may include a web portal service, or web portal 102, at least one paying client 104, at least one web user 106 and at least one external interface 108. In one embodiment, each external interface 108 may include, but not limited to, the Internet, a broadcasting means, a paying client's internal company workflow and a third party interface. In the exemplary embodiment, each paying client 104 and each web user 106 may be coupled in communication to web portal 102 using a network 110. In the exemplary embodiment, network 110 may be the Internet. In an alternative embodiment, network 110 may be a local area network (LAN), a wireless LAN, a wide area network (WAN) and/or any other connection that enables web system 100 to function as described herein.

In the exemplary embodiment, paying clients 104 may be any entity that is registered with web portal 102 such as, but not limited to, advertising agencies, advertisers, companies and corporations that desire to find new products to sell or new technology to develop. In one embodiment, products may be advertising or advertising related materials. Web users 106 may be any entity that is registered with web portal 102 and that designs and/or submits ideas for products thereto. In one embodiment, web users 106 may be the general public.

In the exemplary embodiment, web portal 102 may facilitate providing a centralized location, or virtual meeting place on the Internet, that may enable paying clients 104 to acquire products created by web users 106. Specifically, web portal 102 may enable web users 106 to sell those products to paying clients 104. As such, web portal 102 may facilitate preventing the need for paying clients 104 to employ a large amount of engineers, designers and/or other creative or innovative people on a permanent basis. As a result, web system 100 may facilitate reducing the time and cost of creating products.

Web portal 102, in the exemplary embodiment, may include at least one server 112, at least one first database 114, at least one second database 116 and at least one storage device, or archive 118. Web portal 102 may represent a front end interface, processor engines and physical entities such as, but not limited to, servers, databases and storage devices. In the exemplary embodiment, server 112 may be coupled in communication to first database 114, second database 116 and archive 118 using a network connection 119 such as, but not limited to, a LAN, a wireless LAN, a WAN and/or any other connection that enables web portal 102 to function as described herein. Moreover, web portal 102, and more specifically server 112, may be coupled in communication to external interface 108 using any connection method known to one having ordinary skill in the art to enable web system 100 to function as described herein.

In the exemplary embodiment, the term “server” may refer to a computer that includes a processor (not shown), a memory (not shown), a plurality of inputs (not shown) and a plurality of outputs (not shown). As used herein, the term “server” is not limited to just those integrated circuits referred to in the art as a computer, but broadly refers to a processor, a microcontroller, a microcomputer, a programmable logic controller, an application specific integrated circuit and other programmable circuits. These aforementioned terms may be used interchangeably herein. In one exemplary embodiment, memory may include, but is not limited to, a computer-readable medium, such as a random access memory. Alternatively, a floppy disk, a compact disc-read only memory (CD-ROM), a magneto-optical disk (MOD) and/or a digital versatile disc (DVD) may also be used. In another embodiment, the plurality of inputs may include, but not limited to, computer peripherals associated with an operator interface such as a mouse (not shown) and/or a keyboard (not shown). Furthermore, the plurality of outputs may include, but not be limited to, an operator interface monitor (not shown).

In the exemplary embodiment, server 112 may include a plurality of engines programmed therein. Alternatively, a plurality of servers 112 may be used, wherein each server 112 may include at least one engine programmed therein. As used herein, the term “engine” may refer to a collection of logic and/or code that may be executed on server 112. In the exemplary embodiment, server 112 may include an account management engine (AME) 120, a tools engine 122, a search engine 124, a filter engine 126, an archive engine 128, an export engine 130 and a royalty engine 132. Alternatively, server 112 may include any type of engine that enables web system 100 to function as described herein.

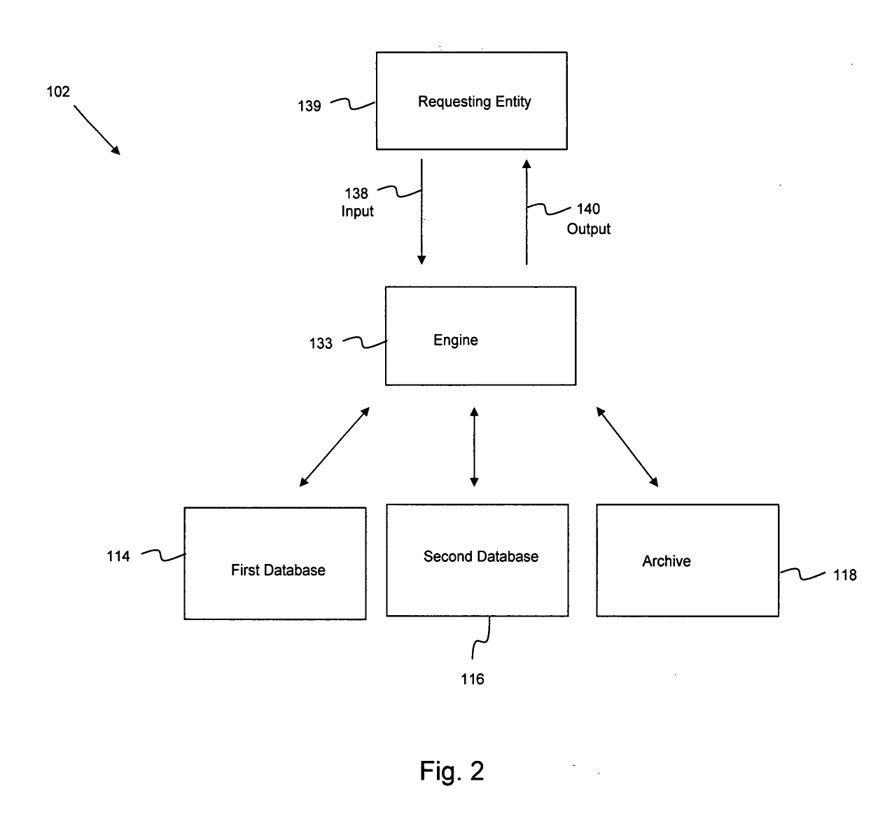

FIG. 2 is a logical schematic illustration of a web portal 102. In the exemplary embodiment, engines 120, 122, 124, 126, 128, 130 and 132 (shown in FIG. 2 as engine 133) may each run on server 112 and may be each coupled in communication to at least one of first database 114, second database 116 and archive 118. During operation, at least one engine 133 may be triggered externally by a requesting entity 139 such as, but not limited to, web user 106 or paying client 104. Alternatively, at least one engine 133 may be triggered internally by software running on server 112. Specifically, in the exemplary embodiment, each engine 133 may be triggered by receiving a request for information, or input 138 from requesting entity 139. Input 138 may include, but not limited to, search criteria, save requests and/or collaboration requests. Once engine 133 receives input 138, engine 133 may query at least one of first database 114, second database 116 and archive 118 for a specific set of data. After receiving the appropriate data, engine 133 may transmit an output 140 to requesting entity 139.

At least one paying client 104 and at least one web user 106 may be coupled in communication to server 112. In the exemplary embodiment, server 112, and more specifically AME 120, may facilitate registering paying clients 104 and web users 106 with web portal 102 and may also facilitate managing the accounts of paying clients 104 and web users 106. Specifically, AME 120 can enable paying clients 104 and web users 106 to enter their address and contact information into their respective accounts. Moreover, AME 120 can enable paying clients 104 to pay fees and enable web users 106 to collect royalties.

Tools engine 122, in the exemplary embodiment, may facilitate providing web collaboration tools (not shown) and/or proxy-based editing and content/creation tools (not shown) to each paying client 104 and each web user 106. Specifically, in the exemplary embodiment, the web collaboration tools of tools engine 122 may enable collaboration between a plurality of paying clients 104 or between at least one paying client 104 and at least one web user 106. Web users 106 may use tools engine 122 to upload products and collaborate on products with at least one other web user 106 and/or at least one paying client 104. The proxy-based editing and content/creation tools may also enable multiple-party editing of uploaded products and/or creating a final version of the products. Moreover, tools engine 122 may perform “behind the scenes” editing to facilitate creating the finalized product.

In the exemplary embodiment, filter engine 126 may facilitate filtering products uploaded by web users 106 to facilitate accepting products that are relevant to the paying client's 104 business. In one embodiment, filter engine 126 may facilitate directing at least one web user 106 to a specific theme or category stored within at least one of first database 114, second database 116 and archive 118. Moreover, filter engine 126 may facilitate filtering products uploaded by web users 106. Specifically, in the exemplary embodiment, as described in more detail below, filter engine 126 may compare a plurality of metrics specific to the uploaded product with a corresponding plurality of pre-determined metrics. Furthermore, filter engine 126 may notify web users 106 as to whether their uploaded products were accepted by sending either an acceptance notice or a rejection notice. In the exemplary embodiment, filter engine 126 may facilitate tagging uploaded products with a specific theme and category. In one embodiment, tagging categories may include, but not limited to, title, description and/or language.

Archive engine 128, in the exemplary embodiment, may facilitate storing accepted products within archive 118. Moreover, archive engine 128 may automatically store the products in archive 118 once the products are accepted by filter engine 126. In an alternative embodiment, an administrator may be prompted to manually store the product within archive 118. In the exemplary embodiment, archive engine 128 may facilitate sorting the contents of archive 118 into themes and categories. Furthermore, archive engine 128 may publish the themes and categories of the accepted products on at least one of first and second databases 114 and 116 to enable web users 106 to efficiently search the accepted products. Moreover, archive engine 128 may also publish web user 106 information and product information on at least one of first and second databases 114 and 116.

Search engine 124, in the exemplary embodiment, can enable paying clients 104 to search archive 118 for accepted products uploaded by web users 106. Specifically, search engine 124 can enable web users 106 to search the product themes and/or categories published on at least one of first and second databases 114 and 116.

In the exemplary embodiment, export engine 130 may facilitate exporting products selected by paying clients 104 from archive 118 to a pre-selected external interface 108. Additionally, export engine 130 may send a confirmation notice to paying client 104 once the product is exported. Moreover, in the exemplary embodiment, royalty engine 132 may calculate a royalty payment for the at least one web user 106 who uploaded the exported product. As described in more detail below, royalty engine 132 may utilize a variety of rules, or factors in determining a royalty fee or fees, wherein the factors may be complex and dynamically loaded.

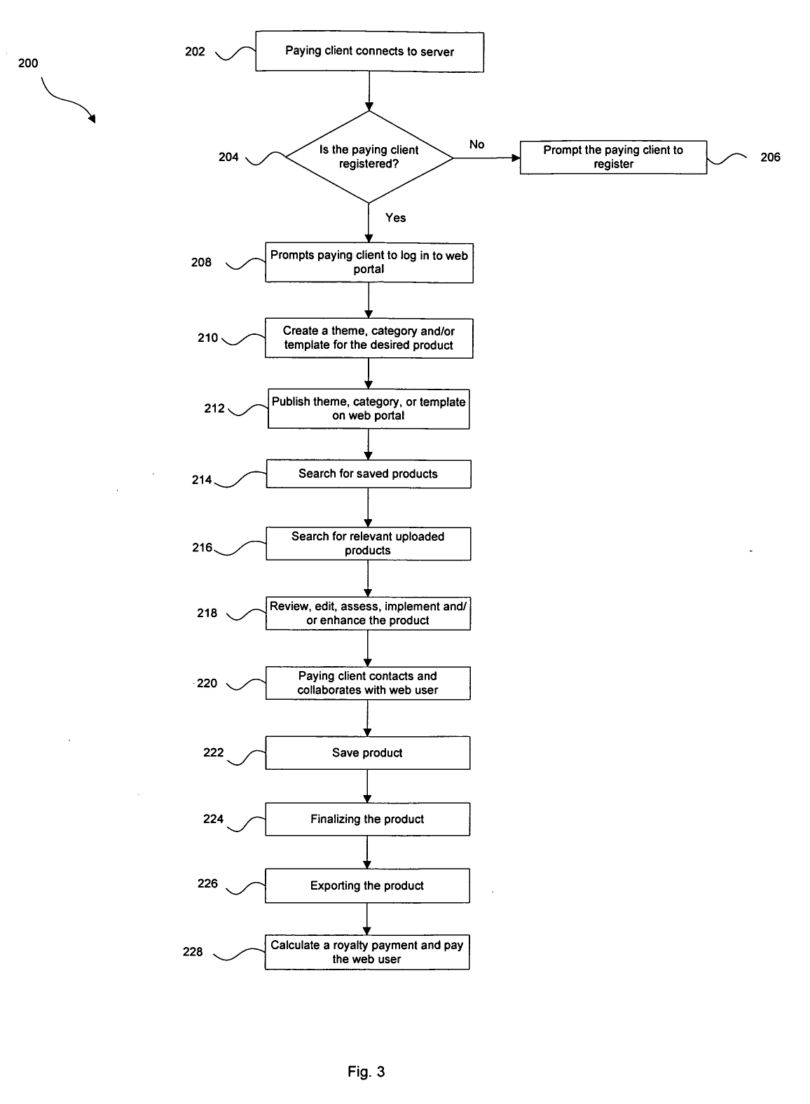

During operation of web system 100, at least one paying client 104 and at least one web user 106 connect to web portal 102. FIG. 3 is a flow chart of an exemplary method 200 of connecting at least one paying client 104 to web portal 102. In the exemplary embodiment, in method step 202, at least one paying client 104 may connect to web portal 102, and more specifically, server 112 using network 110. In method step 204, AME 120 may determine whether paying client 104 is registered with web portal 102. If paying client 104 is not registered with web portal 102, in method step 206, AME 120 may prompt paying client 104 to register with web portal 102. Registration of paying client 104 may include, but not limited to, creating a unique username and password and/or the payment of registration fees to the administrator of web portal 102. In one embodiment, the registration fee may be a one time fee. In another embodiment, the registration may be a recurring fee. In yet another embodiment, the registration fee may be billed and paid in any way know to one having ordinary skill in the art, such that web system 100 functions as described herein. In method step 208, in the event paying client 104 may be registered with web portal 102, AME 120 may prompt paying client 104 to log in to web portal 102 by entering a username and password to access web portal 102.

In the exemplary embodiment, once paying client 104 is registered and logged on to web portal 102, in method step 210, paying client 104 may create at least one of a product theme (not shown), a product category (not shown) and a product template (not shown). In method step 212, each product theme, category and template may be published on web portal 102. In one embodiment, the product theme and category may relate to, but not limited to, fields of technology in which paying clients 104 are innovating in or wish to innovate in, products paying clients 104 seek assistance in innovating and/or general concepts paying clients 104 want to enhance or improve. In yet another embodiment, the product template may include, but not limited to, paying client's 104 product preferences (e.g. humor, cars, watches, etc.), product target data and goals, paying client 104 biographical and contact information, royalty payment information and/or links to other templates. Each product template may be dynamically updated with new product categories by paying clients 104. In another embodiment, as described in more detail below, paying clients 104 may also post banners or other forms of advertising on web portal 102 such that web users 106 may see the postings and click on them if the postings are relevant to web users' 106 products.

In the exemplary embodiment, in method step 214, paying clients 104 may search for saved products that have been previously reviewed and/or edited. In one embodiment, paying clients 104 may search for saved products that are stored on at least one of first database 114, second database 116 and archive 118 using search engine 124. In an alternative embodiment, paying client 104 may search for saved products that are stored on a local device that is maintained by the paying client 104. In the event that no products have been saved, in method step 216, paying clients 104 may search for relevant uploaded products that are stored on at least one of first database 114, second database 116 and archive 118. Uploaded products may include, but not limited to, full product disclosures, completed products and/or partially completed products. In one embodiment, paying client 104 may utilize a web portal feature that converts uploaded videos into image storyboards to facilitate previewing videos rather than downloading videos. In another embodiment, paying clients 104 may click on uploaded videos during video playback, which displays web user's 106 website and/or preferred portal. Moreover, the uploaded video may transmit, simultaneously or at a later time, information back to web user 106 indicating that the video has been viewed.

In the exemplary embodiment, in method step 218, once the product is found and retrieved, paying clients 104 may review, edit, assess, implement and/or enhance the product. Moreover, in method step 220, paying clients 104 may contact and collaborate with at least one web user 106. In one embodiment, paying client 104 may collaborate with the at least one web user 106 who uploaded the product. In another embodiment, paying clients 104 may collaborate with at least one web user 106 to create new ideas, products and/or concepts. In the exemplary embodiment, collaboration may include, but not limited to, at least one paying client 104 and at least one web user 106 discussing, enhancing and/or editing the uploaded product. In one embodiment, web portal 102 may include software, such as a virtual drawing board, that facilitates collaboration between at least one paying client 104 and at least one web user 106. In another embodiment, the virtual drawing board may facilitate editing storyboard images and/or video data by extracting data from one image or video clip and inserting it into another image or video clip. In yet another embodiment, paying clients 104 may use the virtual drawing board to create or edit products that they can easily preview to clients. As a result, each paying client 104 and web user 106 may discuss and/or edit the product together to facilitate reducing the time and cost required to create a product.

In the exemplary embodiment, in method step 222, after the product is reviewed, edited and/or collaborated on with web user 106, the product may be saved to at least one of first database 114, second database 116 and archive 118. In an alternative embodiment, the product may be stored locally on a device maintained by paying client 104. In such an embodiment, products that are stored or retrieved from local devices maintained by paying client 104 may include a Digital Rights Management (DRM) layer. The DRM layer facilitates preserving the web user's 106 rights and facilitates preventing theft of products. In another embodiment, uploaded products, such as videos and images may include either an audio, video or image watermark that is inserted by web portal 102. In such an embodiment, the watermark may include a user or transactional identifier to facilitate tracking the each video and image such that the web user's 106 rights therein are preserved. In one embodiment, the watermark tracks the product's use, which facilitates rating and ranking web users 106 and/or the product, as described below in more detail.

In method step 224, web portal 102 may finalize the product such that a final version of the product is created. Finalization of the product may include, but not limited to, further reviewing, editing, collaboration and/or formatting by at least one of paying clients 104 and/or web users 106. Specifically, in the exemplary embodiment, finalization of the product may enable paying clients 104 to create high-quality versions of the product. In one embodiment, high-quality versions of the product may be, but not limited to, broadcast-ready advertising. Each paying client 104 that finalizes a product may be charged a finalization fee by web portal 102.

In method step 226, once paying client 104 is satisfied with the product, paying client 104 pays web portal 102 an amount of money to export the product such that the product may be exported to paying client 104 using export engine 130 via external interface 108. Specifically, in the exemplary embodiment, the products may be exported to any type of device maintained by paying client 104. In one embodiment, the product may be exported to paying client 104 using communication devices such as, but not limited to, email, mobile phones, personal digital assistants (PDAs) and/or secured websites. In another embodiment, the final product may be published, or delivered to, a content hosting website, such as, but not limited to, www.youtube.com. In another embodiment, the exported product may be stored in at least one of first database 114, second database 116 and archive 118 such that only the paying client 104 who created, viewed or otherwise utilized the product may access and/or view the product. In another embodiment, the product may be stored in at least one of first database 114, second database 116 and archive 118 such that any paying client 104 logged into web portal 102 may access and/or view the product. In yet another embodiment, the final product may be sent to a broadcasting entity.

In the exemplary embodiment, in method step 228, once the product is exported to paying client 104, royalty engine 132 may calculate a royalty payment that may be paid to the at least one web user 106 who uploaded the product. In one embodiment, the royalty payment may be a single payment, a recurring payment or some combination thereof. Each royalty payment may be based on any factor or combination of factors. In the exemplary embodiment, the royalty payment factors may include, but are not limited to, the amount of time spent working on the product, the creativity of the product, the ease with which the product can be brought or shown to the market, the amount of times the product is viewed or purchased and/or any other factors. In another embodiment, the royalty payments may be based on the amount of material that web user 106 generated for a finalized product and/or the length, or size, of the finalized product. If a plurality of web users 106 contributed to the finalized product, each web user 106 may receive a pro rata royalty payment based on their individual contributions. For example, an advertising video is uploaded by a first web user is 30 seconds long and includes approximately 900 frames. If the finalized product uses 100 frames from the first web user's video and 90 frames from a second web user's video, then the first web user may be entitled to 11% of an allocated royalty payment because the first web user contributed 11% of the frames (100 out of 900 frames). The second user may then be entitled to 10% of the allocated royalty payment for contributing 10% of the frames (90 frames out of 900).

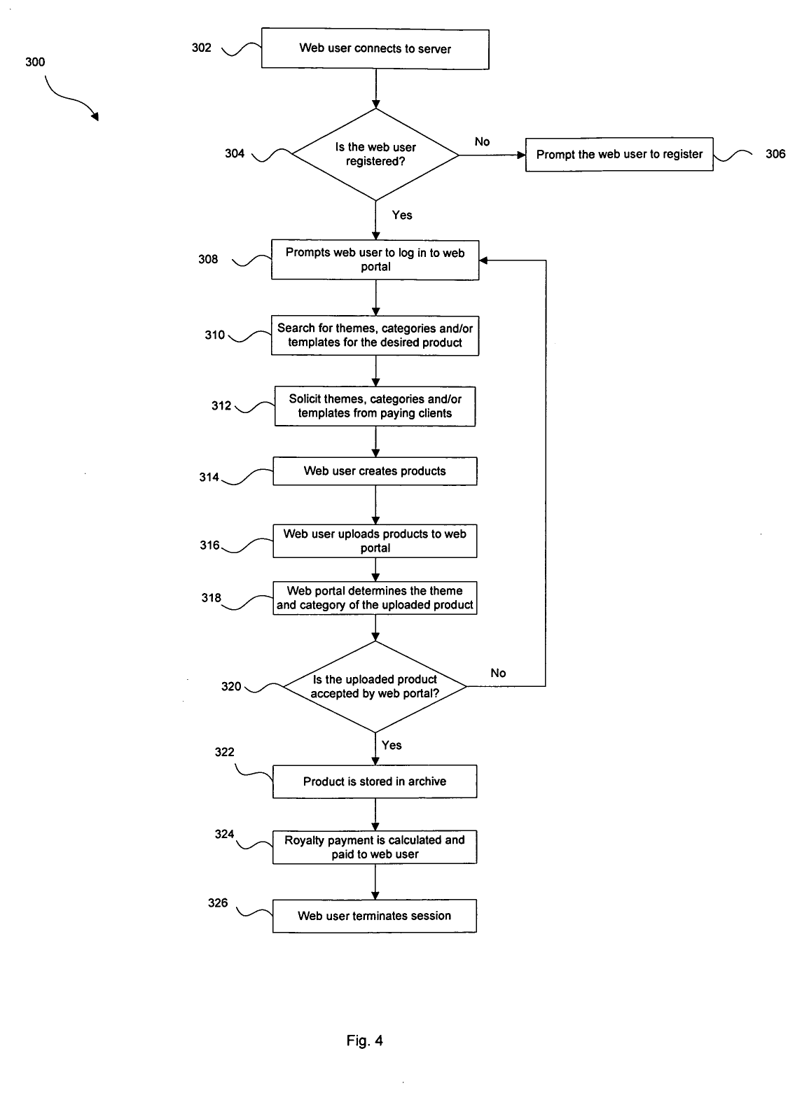

FIG. 4 is a flow chart of an exemplary method 300 of connecting at least one web user 106 to web portal 102. In the exemplary embodiment, in method step 302, at least one web user 106 may connect to web portal 102, and more specifically, server 112 using network 110. In method step 304, AME 120 may determine whether web user 106 is registered with web portal 102. If web user 106 is not registered with web portal 102, in method step 306, AME 120 may prompt web user 106 to register with web portal 102. Registration of web user 106 may include, but not limited to, creating a unique username and password and/or the payment of registration fees to the administrator of web portal 102. In the event web user 106 is registered with web portal 102, in method step 308, AME 120 may prompt web user 106 to log in to web portal 102 by entering a username and password to access web portal 102.

In the exemplary embodiment, in method step 310, web user 106 may search web portal 102 for product themes, categories and/or templates that are relevant to the themes and categories in which the web user 106 desires to create products. Moreover, while searching for products, web users 106 may view banners or other forms of advertisement created by paying clients 104. Each of the banners and advertisements may include at least one hyperlink to specific paying clients 104. In the event web user 106 does not find the desired product theme, category and/or template, in method step 312, web user 106 may solicit specific product themes, categories and/or templates from paying clients 104. In method step 314, web user 106 may create products that are relevant to the found or solicited themes and categories. In one embodiment, web users 106 may create final products using web portal 102 tools, as described in more detail below. Alternatively, web users 106 may have previously created products which are relevant to the found or solicited themes and categories.

In method step 316, web user 106 may upload products to web portal 102. In one embodiment, the uploaded products may be, but not limited to, advertising videos or a series of pictures, or images in a storyboard format. The videos may be, for example, between 30 and 90 seconds in length, or any other desired length, and may be in any known video format including, but not limited to .wmv, .mpeg, .qt, etc. In the exemplary embodiment, uploaded videos may be automatically converted into a virtual storyboard format that includes a plurality of video images. The uploaded images may also be in any known image format including, but not limited to jpeg, gif, etc. In method step 318, once the product is uploaded by web user 106, web portal 102 may determine the proper theme and category of the product based on, but not limited to, the product title, description, subject matter, category, language and any other classification that enables web portal 102 to function as described herein. In one embodiment, web users 106 may tag their uploaded products with themes and/or categories such as, but not limited to, humor cars, watches, etc. Once the proper theme and/or category of the product is determined, the product is tagged with that theme and/or category.

In the exemplary embodiment, in method step 320, after the product is tagged, filter engine 126 may determine whether the uploaded product is accepted. In one embodiment, filter engine 126 may automatically filter the uploaded products by isolating and comparing various aspects of the uploaded products with pre-determined aspects of known or desired products to paying clients 104. In another embodiment, filter engine 126 may prompt an administrator to manually inspect and filter uploaded products. In yet another embodiment, filter engine 126 may filter the product based on whether the product is violating of a copyright. In the exemplary embodiment, filter engine 126 may filter uploaded products using a plurality of factors including, but not limited to, the relevance of the product to the searched themes and categories, the appropriateness of the uploaded product, the similarity of the uploaded product to other, previously uploaded products, the similarity of the uploaded products to copyrighted products and/or any other desired criteria. In one embodiment, filter engine 126 may establish a level of quality control by comparing a standard of quality of the uploaded products to a pre-determined standard of quality. Specifically, filter engine 126 may accept products that include a standard of quality that is above the pre-determined standard and may reject products that include a standard of quality that is below the predetermined standard.

Filter engine 126, in the exemplary embodiment, may send the web user 106 whose product was accepted a notice of acceptance. In one embodiment, filter engine 126 may send a rejection notice to web users 106 whose content is rejected by web portal 102. In another embodiment, at least one reason for rejection may be included within the rejection notice. In the event the product is not accepted, web portal 102 may send web user 106 back to method step 310. In one embodiment, filter engine 126 may provide web user 106 with a plurality of products that have been tagged with similar themes and/or categories as the paying client's 104 product preferences. In such an embodiment, web users 106 may integrate the provided products into an upload product.

In the exemplary embodiment, in method step 322, after the product is accepted, filter engine 126 may outputs the accepted product to archive engine 128 which stores, or archives, the product in archive 118. Moreover, after uploaded content is accepted by filter engine 126, paying client 104 can search, review, edit and/or accept/reject the uploaded product and/or collaborate with at least one web user 106, as described above. Changes made to the product by paying client 104 may be communicated to the web user 106 who may then accept or reject the changes. Furthermore, in method step 324, if the uploaded content is used or edited as part of a finished product, a royalty payment may be calculated and paid to the at least one web user 106, as described above. In method step 326, after the royalty payment is paid, web user 106 may terminate their session and/or their association with the project for which the royalty was paid and begin another search in method step 304.

Finally, web portal 102 may be used to rank and rate web users 106. For example, web portal 102 may evaluate the number of acceptances or the level of acceptance rates of web users 106. A higher level of acceptances for products may give that web user 106 a higher ranking or rating. Moreover, the watermarks included in each final product may track the product's use, which facilitates rating and ranking web users 106 and/or the product. The higher ranking or rating can, in turn, lead to a higher royalty level or higher amount paid to the web user 106. Additionally, paying clients 104 could use the ratings to help determine which web users 106 they wish to correspond with.

Web portal 102 serves as a cost effective means for paying clients 104 to introduce additional creativity into their products, designs and ideas. As such, web portal 102 may facilitate preventing the need of a large amount of engineers, designers or other creative and/or innovative people on a permanent basis. In one embodiment, web portal 102 may be used by purchasers of advertising for the planning and creation of advertisements. In such an embodiment, the advertisements may be based on or inspired by video data uploaded by web users 106. In a further embodiment, the web portal can create an advertising campaign or theme based on paying client's 104 requirements, and can solicit creative input from web users 106 based upon those requirements. Web users 106 can benefit from this scenario as well because they can be paid in royalties from the data they submit. Thus the web portal and resultant royalty fees can be used to supplement the income of a user 106 insofar as it would be a constructive creative outlet.

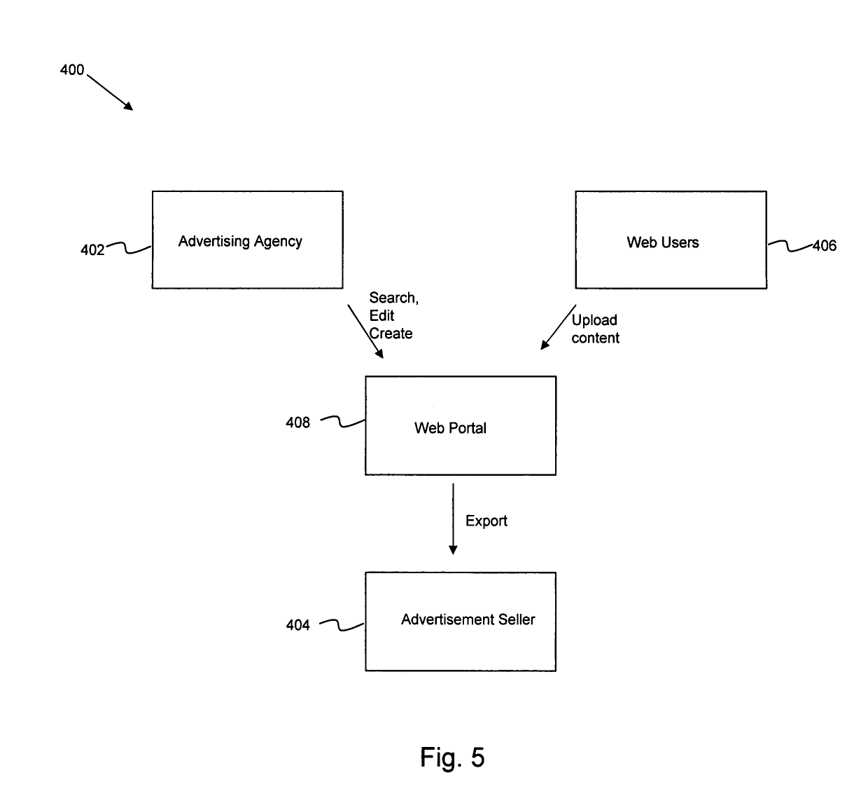

FIG. 5 is a logical schematic illustration of an alternate web system 400. In the exemplary embodiment, web system 400 facilitates connecting an advertising agency 402, an advertisement seller 404 and people outside of the advertising field, or web users 406, to web portal 408. Alternatively, web system 400 may be configured to connect entities in any business filed such as, but not limited to, product design, fashion design, computer aided design models, movie and television themes and any other stream of commerce.

In the exemplary embodiment, advertising agency 402, advertising seller 404 and at least one web user 406 are each coupled in communication to web portal 408. Moreover, web system 400 may enable collaboration between at least one advertising agency 402, at least one advertising seller 404 and at least one web user 406. In the exemplary embodiment, web system 400 may function substantially similar to web system 100. During operation, advertising agency 402 may first search for content related to their targeted product or concept using portal web 408. At least one web users 406 may have previously uploaded advertising content, in the form of videos or images, to portal 408. After finding some desired content, advertising agency 402 may edit the content, either with or without the assistance of the at least one web user 406 who created the content, use the content as inspiration for new material or work with the at least one web user 406 to create new content. In one embodiment, web user 406 may be paid some form of royalty for creating or helping create content. In another embodiment, as described above, web portal 408 may create an advertising campaign and/or advertising theme based on advertising agency's 402 requirements. Moreover, in such an embodiment, web portal 408 may solicit products relevant to the advertising campaign and/or theme from web users 406.

After advertising agency 402 develops and finalizes their advertisement, they may export the advertisement to and advertisement seller 404, for example a television station or website, and the advertisement may be displayed in some manner. This exportation may be done in any manner known to one having ordinary skill in the art.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of exchanging a product between a plurality of parties comprising:
connecting at least one first party and at least one second party to a web portal;
creating a product by the at least one second party;
uploading the product to the web portal by the at least one second party;
viewing the product on the web portal by the at least one first party;
facilitating communication between the at least one first party and the at least one second party using the web portal to enable collaboration on the product;
editing the product based on the communication; and
exporting the product to the at least one first party.

2. A method in accordance with claim 1 wherein the product is at least one of a concept, design, idea and model.

3. A method in accordance with claim 1 further comprising calculating a royalty payment for the at least one second party, wherein the royalty payment is paid to the at least one second party.

4. A method in accordance with claim 3 further comprising filtering received products to facilitate accepting products relevant to a business of the at least one first party.

5. A method in accordance with claim 1 further comprising determining at least one of a theme and a category for the product.

6. A method in accordance with claim 5 further comprising searching at least one of the themes and categories of each product.

7. A method in accordance with claim 1 wherein said step of finalizing the product further comprises reviewing the product by at least one of the at least one first party and the at least one second party.

8. A method in accordance with claim 1 wherein said step of finalizing the product further comprises collaborating between the at least one first party and the at least one second party to facilitate creating a product.

9. A computer program embodied on a computer-readable medium, said computer program comprising at least one code segment configured to instruct a computer to:
connect at least one first party and at least one second party to a web portal;
receive a product created by the at least one second party;
finalize the product; and
export the product to the at least one first party.

10. A computer program in accordance with claim 9 further comprising at least one code segment configured to determine at least one of a theme and category for the product.

11. A computer program in accordance with claim 9 further comprising at least one code segment configured to calculate a royalty payment for the at least one second party.

12. A computer program in accordance with claim 11 further comprising at least one code segment configured to pay the royalty payment to the at least one second party.

13. A computer program in accordance with claim 9 further comprising at least one code segment configured to filter received products to facilitate accepting products relevant to a business of the at least one first party.

14. A computer program in accordance with claim 9 further comprising at least one code segment configured to search at least one of the themes and categories of each product.

15. A web system comprising:
at least one database;
at least one archive; and
at least one server coupled in communication with said at least one database and said at least one archive, wherein at least one first party and at least one second party are coupled in communication to said at least one server, and said at least one server is configured to:
connect the at least one first party and the at least one second party to said at least one server;
receive a product created by the at least one second party;
finalize the product; and
export the product to the at least one first party.

16. A web system in accordance with claim 15 wherein said server is further configured to calculate a royalty payment for the at least one second party.

17. A web system in accordance with claim 16 wherein said server is further configured to pay the royalty payment to the at least one second party.

18. A web system in accordance with claim 15 wherein said server is further configured to determine at least one of a theme and a category for the product.

19. A web system in accordance with claim 18 wherein said server is further configured to search at least one of the themes and categories of each product.

20. A web system in accordance with claim 15 wherein said server is further configured to filter received products to facilitate accepting products relevant to a business of the at least one first party.
